(19) United States
(12) Patent Application Publication
(10) Pub. No.: US 2026/0228503 A1
(43) Pub. Date: Aug. 6, 2026

(54) CLUSTER-BASED GENERATION OF INSTRUCTIONAL CONTENT USING GENERATIVE ARTIFICIAL INTELLIGENCE TECHNIQUES

(71) Applicant: Dell Products L.P., Round Rock, TX (US)

(72) Inventors: Sumit Wadhwa, Austin, TX (US); Souvik Nath, Howrah (IN); Prateek Srivastava, Cedar Park, TX (US); Jesse Preston Williams, Boise, ID (US); Satish Yashwant Patil, Austin, TX (US)

(21) Appl. No.: 19/046,722

(22) Filed: Feb. 6, 2025

(51) Int. Cl. G06N 3/0475; G06N 3/09

(52) U.S. Cl. CPC G06N 3/0475; G06N 3/09

(57) ABSTRACT

Techniques are provided for cluster-based generation of instructional content using generative artificial intelligence (AI). One method comprises obtaining information characterizing an interaction between a first and second user; applying at least a portion of the obtained information to a generative AI model, wherein the generative AI model employs a language model that is tuned using labeled interaction data of an organization associated with the first user and domain-specific knowledge for the organization, wherein the generative AI model generates information characterizing instructional content, related to the interaction, for the first user based on a cluster assignment of the first user to a given user cluster of multiple user clusters, and wherein the multiple user clusters are generated by applying a supervised clustering algorithm to (i) attributes of users associated with the organization and (ii) a designated organization objective of the organization; and initiating an automated action based on the instructional content.

### BACKGROUND

As the value and use of information continues to increase, individuals and organizations seek additional ways to process and/or store information. Information processing systems may be used to process, compile, store and/or communicate various types of information, for example, including through the use of artificial intelligence (AI) and/or machine learning (ML).

### SUMMARY

Illustrative embodiments of the disclosure provide techniques for cluster-based generation of instructional content using generative AI. One method includes generating at least one data structure comprising information characterizing at least a portion of an interaction between at least a first user and a second user; applying at least a portion of the data structure to at least one generative AI model, wherein the generative AI model employs at least one language model that is tuned using labeled interaction data of an organization associated with the first user and domain-specific knowledge for the organization, wherein the generative AI model generates information characterizing instructional content, related to the interaction, for the first user based at least in part on a cluster assignment of the first user to a given user cluster of a plurality of user clusters, and wherein the plurality of user clusters is generated by applying a supervised clustering algorithm to (i) one or more attributes of a plurality of users associated with the organization and (ii) at least one designated organization objective of the organization; and initiating at least one automated action based at least in part on the instructional content.

Illustrative embodiments can provide significant advantages relative to conventional techniques. For example, technical problems related to such conventional techniques are mitigated in one or more embodiments by employing cluster-aware generative AI models that generate instructional content for a given user based at least in part on a cluster assignment of the given user.

These and other illustrative embodiments described herein include, without limitation, methods, apparatus, systems, and computer program products comprising processor-readable storage media.

### BRIEF DESCRIPTION OF THE DRAWINGS

FIGS. 1 and 2 illustrate information processing systems configured for cluster-based generation of instructional content using generative AI techniques in accordance with illustrative embodiments;

FIG. 3 is a sample table illustrating user information for a given cluster of users in accordance with an illustrative embodiment;

FIGS. 4 and 5 illustrate an exemplary fine tuning of one or more language models and a processing of one or more prompts by the one or more fine-tuned language models during an inference stage in accordance with illustrative embodiments;

FIG. 6 illustrates an exemplary prompt template for a language model in accordance with an illustrative embodiment;

FIG. 7 illustrates an exemplary architecture for cluster-based generation of instructional content using generative AI techniques in accordance with an illustrative embodiment;

FIGS. 8 and 9 are flow diagrams illustrating exemplary implementations of processes for cluster-based generation of instructional content using generative AI techniques in accordance with illustrative embodiments;

FIG. 10 illustrates an exemplary processing platform that may be used to implement at least a portion of one or more embodiments of the disclosure comprising a cloud infrastructure; and

FIG. 11 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for cluster-based generation of instructional content using generative AI techniques.

One or more aspects of the disclosure recognize that to improve a particular objective of an organization (e.g., to increase sales volume or another metric), it may be important to convert inquiries into actual transactions, regardless of whether a given user uses an online portal or a human representative. As the number of users (e.g., customers) is often large, it is often a challenge to address such inquiries and convert them into actual transactions. When users turn to a human representative, for example, who often has limited capacity, the opportunity to convert inquiries into actual transactions may be missed (e.g., due to a manual processing of the inquiries).

Customers are increasingly encouraged to review item information, available configurations and other available information directly online (e.g., using a self-service model). This is often a mutually beneficial situation, as users will be happy to see all of the available potential options themselves, rather than trying to reach a human representative. Also, users may be able to place an order swiftly, and in turn, this would also increase the customer base of the respective organization (e.g., a manufacturer and/or a retailer). Users can still interact with a human representative (e.g., a salesperson) for the availability of an order or to get additional information. Among other benefits, when users are able to place an order directly online, the users are able to focus on more complex problems and/or more important (e.g., more profitable) users.

The disclosed techniques for cluster-based generation of instructional content using generative AI may be employed to improve a particular objective of an organization. For example, one organization objective may be to increase an online transaction percentage (OTP) that indicates a percentage of transactions performed by an end-user online (as opposed to using other human-based channels, such as human customer service agents or other users).

In one or more embodiments, users are identified that perform well with respect to a particular organization objective (e.g., a key performance indicator (KPI)), such as an OTP. The interactions of such identified users with users (e.g., customers) may be analyzed to develop best practices and other solutions (e.g., using a genAI chatbot). The best practices and other solutions of the higher performing users may be provided as instructional content to assist other users having a lower performance with respect to the particular organization objective.

In some embodiments, the distribution of human representative performance with respect to a given KPI (e.g., an OTP) is evaluated using supervised clustering techniques to generate clusters of similar users and then evaluate user performance. The objective may be to increase online adoption, and instructional support may be provided to users that have a lower performance with respect to the given KPI within the identified peer group (e.g., within a cluster or neighborhood of similar users).

For example, in some embodiments, the users within an organization may be clustered (e.g., using such supervised clustering techniques) based on a target variable (e.g., a KPI-based organization objective) and one or more designated business conditions, such as business unit order mix; transactional order mix; direct order mix; online average order values and total average order value. By using specific business rules for clustering, along with a target variable, such as OTP or a composite value of multiple business objectives, a data-driven and/or business driven approach is provided to cluster users that should have the same or similar values of the target variable, and user performance can be evaluated with respect to the target variable.

Consider a cluster of ten users, for example. If nine of the ten users have 70% of their sales online and 30% of their sales offline, then the tenth human representative may be expected to have similar statistics. If the tenth human representative, however, has 30% of his or her sales online and 70% of offline sales, then the statistics are out of an expected range of parameters. In some embodiments, a performance rating (such as a star rating) may be employed to rank the users in a given cluster, for example, in a range of one star (e.g., underperforming with respect to the given KPI) to four stars (e.g., performing well with respect to the given KPI).

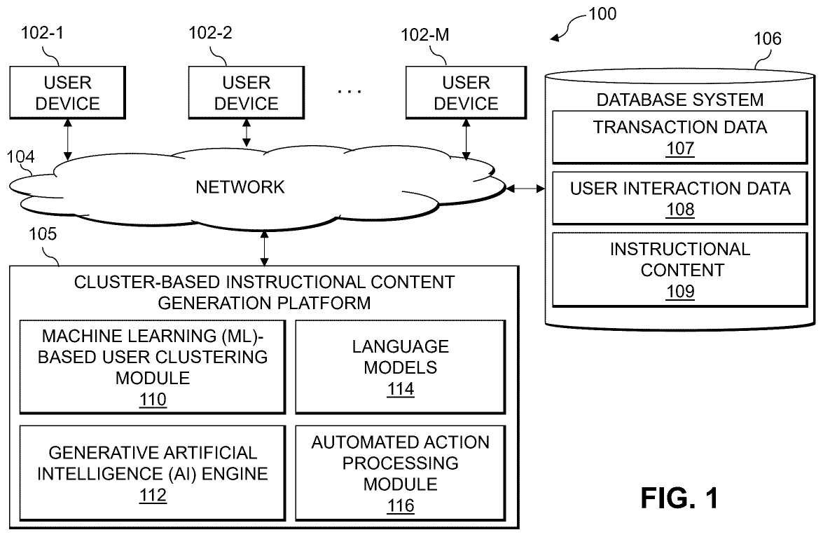

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a cluster-based instructional content generation platform 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

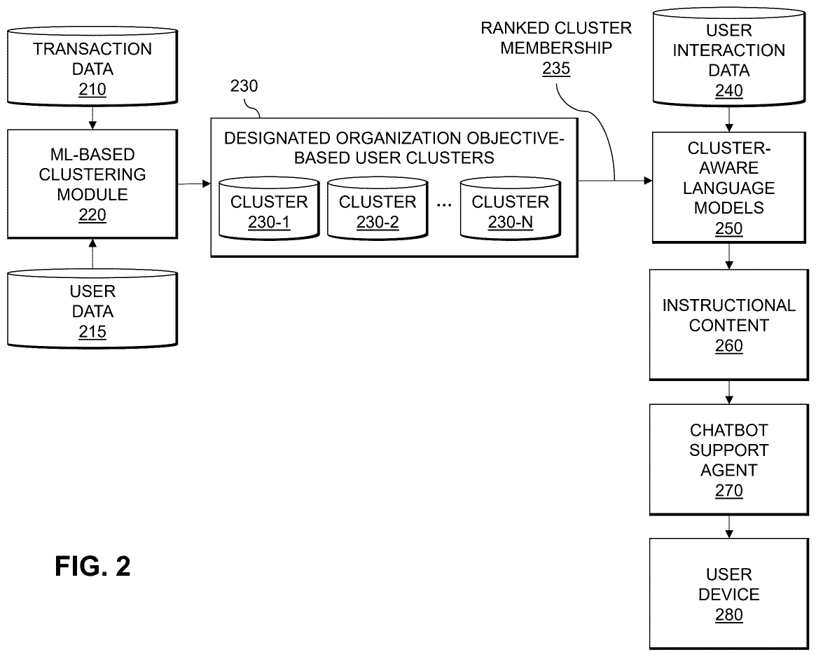

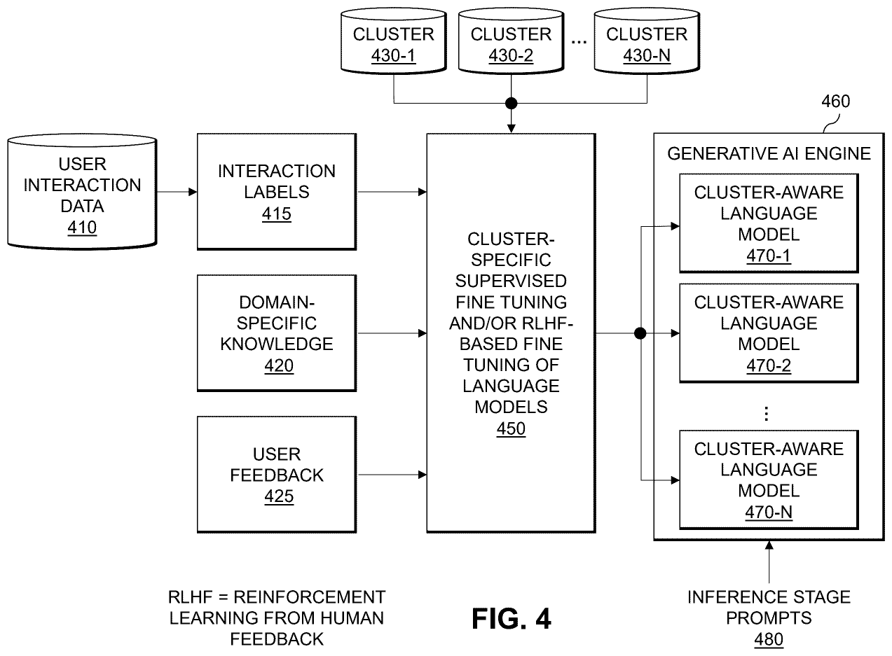

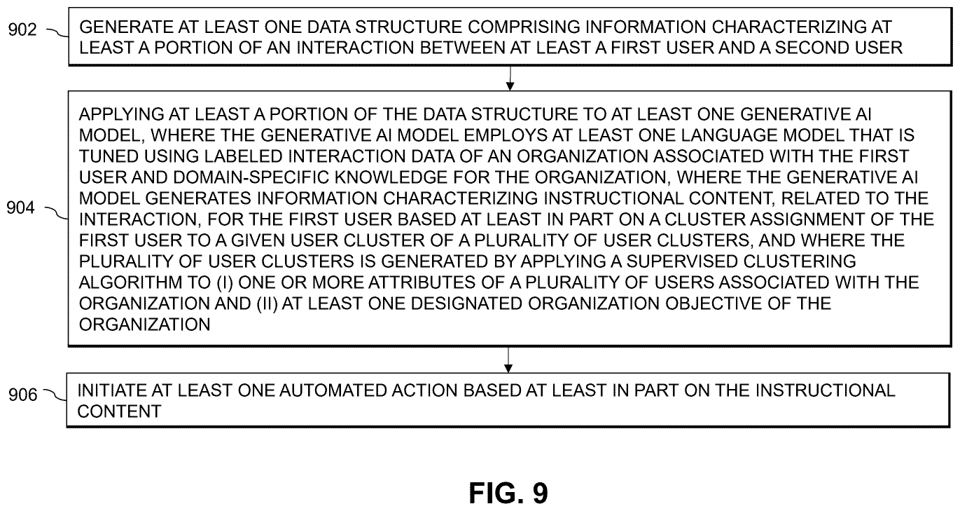

The cluster-based instructional content generation platform 105 may comprise an ML-based user clustering module 110, a generative AI engine 112, one or more language models 114 and an automated action processing module 116. The ML-based user clustering module 110, in some embodiments, may generate one or clusters of users, as discussed further below in conjunction with FIG. 2, for example. In at least some embodiments, the generative AI engine 112 may employ the one or more language models 114 to generate instructional content to help improve a performance of at least one user with respect to at least one designated organization objective, based at least in part on a cluster assignment of the at least one user, as discussed further below in conjunction with FIGS. 4 through 6, for example. In one or more embodiments, the automated action processing module 116 may initiate one or more automated actions based at least in part on the generated instructional content, as discussed further below in conjunction with FIG. 9, for example.

The term “language model” in this context and elsewhere herein is intended to be broadly construed so as to encompass, for example, natural language processing models that are trained on massive amounts of data (e.g., possibly hundreds of gigabytes or more) to understand, summarize, generate and/or predict new content (e.g., instructional content). Such language models are also commonly referred to as large language models. Language models often are implemented using transformer-based architectures. Transformer-based architectures can process input through a sequence of transformers, where each transformer includes a self-attention layer and feed-forward layer. The self-attention layer computes an importance of each token in a sequence of input tokens, and the feed-forward layer transforms the output of the self-attention layer into a form suitable for the next transformer in the sequence. It is noted that this is merely one example of a language model architecture, and other architectures can also be used, such as Long Short-Term Memory (LSTM) architectures.

It is to be appreciated that this particular arrangement of elements 110, 112, 114 and/or 116 illustrated in the cluster-based instructional content generation platform 105 of the FIG. 1 embodiment is presented by way of example only, and alternative arrangements can be used in other embodiments. For example, the functionality associated with the elements 110, 112, 114 and/or 116 in other embodiments can be combined into a single module, or separated across a larger number of modules. As another example, multiple distinct processors can be used to implement different ones of the elements 110, 112, 114 and/or 116 or portions thereof.

At least portions of elements 110, 112, 114 and/or 116 may be implemented at least in part in the form of software that is stored in memory and executed by a processor.

Additionally, the database system 106 may comprise one or more databases, such as a transaction database 107 (e.g., comprising transactions of an organization, as discussed further below in conjunction with FIG. 2), a user interaction database 108 (e.g., comprising information characterizing interactions, such as chat, phone and email-based interactions, of one or more users associated with an organization (e.g., employees) and end users, such as customers), and an instructional content database 109 (e.g., comprising information characterizing generated instructional content). The databases 107, 108 and 109 may be configured to store data, for example, in tables, in a known manner. While the databases 107, 108, and 109 are illustrated in FIG. 1 as comprising distinct databases, at least portions of the databases 107, 108 and 109 may be implemented using a single database (e.g., different parts of a single database). Example databases 107, 108 and 109, such as depicted in the present embodiment, can be implemented using one or more storage systems associated with the cluster-based instructional content generation platform 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the cluster-based instructional content generation platform 105 are one or more input-output devices, which illustratively comprise keyboards, displays or other types of input-output devices in any combination. Such input-output devices can be used, for example, to support one or more user interfaces to the cluster-based instructional content generation platform 105, as well as to support communication between cluster-based instructional content generation platform 105 and other related systems and devices not explicitly shown.

Additionally, the cluster-based instructional content generation platform 105 in the FIG. 1 embodiment is assumed to be implemented using at least one processing device. Each such processing device generally comprises at least one processor and an associated memory, and implements one or more functional modules for controlling certain features of the cluster-based instructional content generation platform 105.

More particularly, the cluster-based instructional content generation platform 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the cluster-based instructional content generation platform 105 to communicate over the network 104 with the user devices 102, and illustratively comprises one or more conventional transceivers.

It is to be understood that the particular set of elements shown in FIG. 1 for the cluster-based instructional content generation platform 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the cluster-based instructional content generation platform 105 and at least portions of the database system 106 can be on and/or part of the same processing platform.

FIG. 2 illustrates an information processing system configured for cluster-based generation of instructional content using generative AI techniques in accordance with an illustrative embodiment. In the example of FIG. 2, an ML-based clustering module 220 processes transaction data 210 (e.g., comprising information characterizing transactions of an organization) and user data 215 (e.g., comprising information characterizing users associated with an organization, such as an existing cluster assignment, if any). The ML-based clustering module 220 generates a plurality of designated organization objective-based user clusters 230-1 through 230-N (e.g., user clusters generated using one or more designated organization objective of a given organization), collectively referred to herein as designated organization objective-based user clusters 230.

In some embodiments, the distribution of human representative performance with respect to a designated organization objective, such as a KPI (e.g., an OTP), is evaluated using supervised or semi-supervised clustering techniques to generate the designated organization objective-based user clusters 230 of similar users. The designated organization objective may be to increase online adoption, and instructional support may be provided to users (e.g., human representatives) that have a lower performance with respect to the given designated organization objective within the identified peer group (e.g., within a cluster or neighborhood of similar users). For example, in some embodiments, the users within an organization may be clustered (e.g., using such supervised clustering techniques) based on a target variable (e.g., a KPI-based organization objective) and one or more designated business conditions, such as business unit order mix; transactional order mix; direct order mix; online average order values and total average order value.

The ML-based clustering module 220 may tune parameters to control a depth of a decision tree or assign weights to the features. All features with assigned weights would be selected for the root node to the leaf node in descending order. In at least one embodiment, a minimum number of samples per leaf node may be set to 20 samples and a maximum number of leaf nodes may be set to 30 leaf nodes. The samples in a single leaf node of the decision tree may be considered a neighborhood or cluster (e.g., as they have been selected by minimizing a mean absolute error (MAE) cost function to develop clusters neighborhoods, where the MAE is the mean absolute of a difference between actual values and predicted values for all data points. A Z score can be calculated to identify lower performing users for each cluster (e.g., those users having a Z score below-1).

A root node of the decision tree may be at the top of the decision tree and the data may be split into different segments until leaf nodes are reached at the bottom of the decision tree. The leaf nodes represent small data segments defined as neighborhoods or clusters (e.g., ideally having the same or similar characteristics with respect to the target problem (e.g., OTP)). The decision tree approach creates neighborhoods based on the specific features considered. The data points in a leaf node follow the same path, which is determined by the shared features of the data points in the leaf node. A traversal of the decision tree from the root node to a given leaf node provides the path that was followed to segment the samples found in the given leaf node and provides samples within a similar group based on the target variable (e.g., OTP). Each cluster also exhibits fewer noisy samples.

In some embodiments, the decision tree can learn from the transaction data 210 and the user data 215 and automatically create the designated organization objective-based user clusters 230 (e.g., neighborhoods). One or more aspects of the disclosure recognize that the clusters of similar users, generated by the ML-based clustering module 220, provide a basis for comparison for any relative performance deviations with respect to the target variable within a given cluster and any shared learnings.

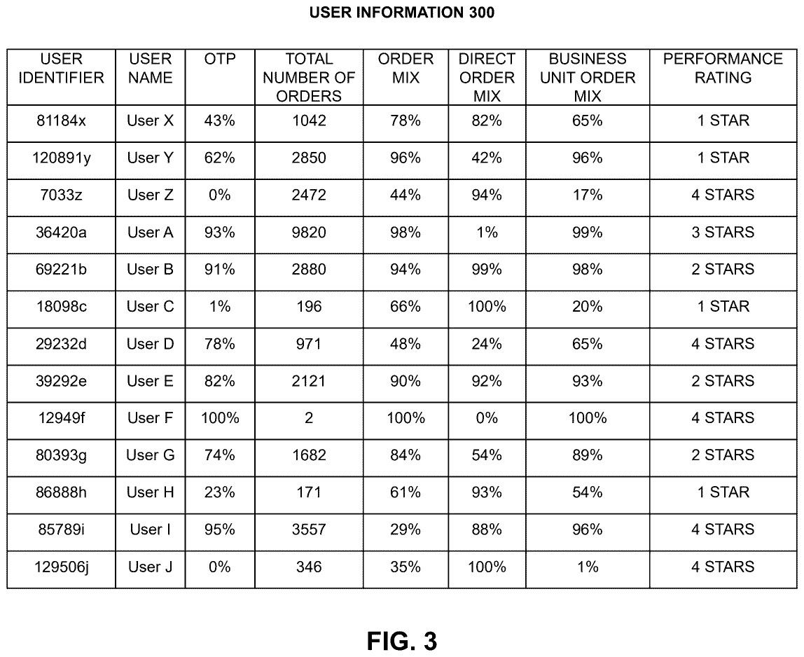

As discussed further below in conjunction with FIG. 3, each designated organization objective-based user cluster 230 comprises a ranked cluster membership 235 of users. One or more cluster-aware language models 250 process the ranked cluster membership 235 of a cluster associated with a given user of interest (e.g., a low performing user), as well as the user interaction data 240 (e.g., comprising information characterizing interactions of one or more users associated with a given organization, such as a sales representative of the given organization with customers of the given organization). The user interaction data 240 may also comprise interaction metadata that indicates, for example, a customer or user sentiment, a conversion status and/or an amount of time that it took to complete a given user interaction).

In one or more embodiments, the cluster-aware language models 250 generate instructional content 260 for the given user based at least in part on the cluster assignment of the given user. In some embodiments, the cluster-aware language models 250 may learn from the transactions in the user interaction data 240 of higher performing users in each cluster. The higher performing users and the lower performing users in a given cluster may be identified using neighborhood-based outlier detection techniques, for example.

The cluster-aware language models 250 may generate instructional content for the given user by analyzing the user interaction data 240 to identify best practices and other solutions of the higher performing users in the ranked cluster membership 235 that will assist the given user having a lower performance with respect to the designated organization objective. The user clusters 230 may be different from one another, each with their own respective properties. A cluster-aware language model 250 will learn cluster-specific patterns and will generate instructional content 260 tailored to the patterns and policies of a specific cluster.

In the example of FIG. 2, the generated instructional content 260 may be delivered to a user device 280 of the given user by means of a chatbot support agent 270. If a given employee of an organization, assigned to a given cluster (e.g., having a high online conversion rate and associated with non-premium customers), is interacting with a customer, for example, a portion of the interactions that have occurred between the given employee and the customer may be applied to the cluster-aware language model 250 associated with the given cluster. For example, the customer may state that “I am looking for a smartphone under $500 with a good camera.” The given employee (e.g., a sales representative) may state that “We have options, such as XYZ. Do you prioritize battery life or screen size?” The interactions may have associated metadata indicating a neutral sentiment and a successful conversion. The generated instructional content 260 from the cluster-aware language model 250 may state “Great job focusing on the customer's needs. Next time, highlight the camera's specifications directly for clarity.” The chatbot support agent 270 may also suggest that the given employee should encourage the customer to visit a web site of the organization for additional details regarding one or more recommended smartphones.

In another example, a second employee of the organization, assigned to a different cluster (e.g., having a low online conversion rate and associated with premium customers having high order values), may be interacting with a second customer. Again, a portion of the interactions that have occurred between the second employee and the second customer may be applied to the cluster-aware language model 250 associated with the different cluster. For example, the second customer may state that “What are the best servers currently available with GPUs?” The second employee (e.g., a sales representative) may state that “You can go to a GPU section of OrganizationA. com to find the best-selling servers.” The generated instructional content 260 from the cluster-aware language model 250 may state “This specific customer has a history of placing large orders directly with sales representatives. Before the second customer is asked to go online, please inquire more about specific needs, and provide the second customer with an appropriate link or take the order directly.”

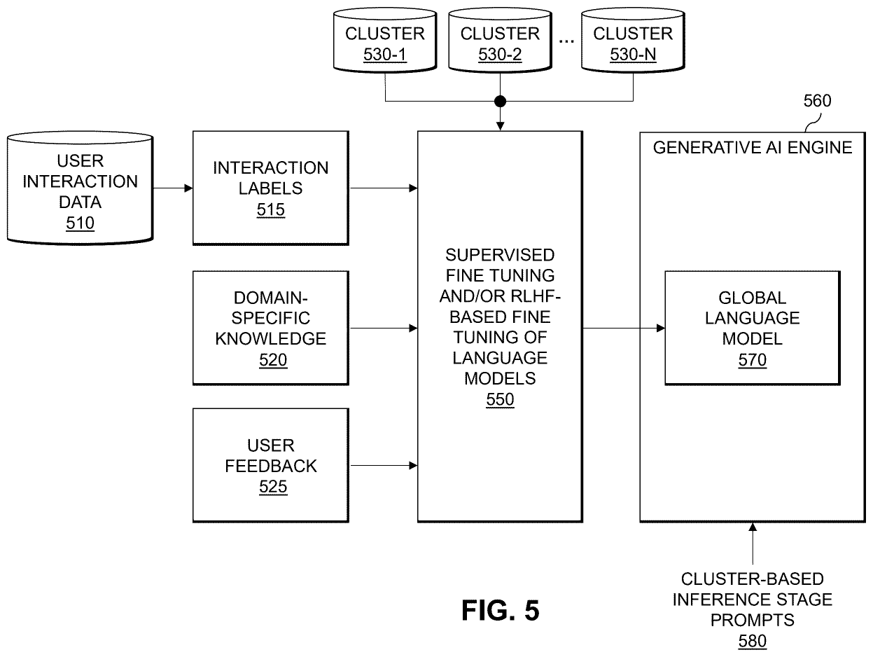

The cluster-aware language models 250 may be implemented in some embodiments using one or more generative pre-trained transformers (e.g., GPTs or Llama). In some embodiments, the GPTs may be fine-tuned using domain-specific knowledge of the organization as well as labeled interaction data to generate instructional content for lower performing users, for example, as discussed further below in conjunction with FIGS. 4 and 5. The GPTs may review historical transactions processed in the past, to predict successful ways to process current transactions, for example. The GPT may comprise an input layer, X, a set of hidden layers, H, and an output layer, Y, in a known manner. It is noted that in some embodiments, multiple GPTs may be employed in parallel.

In at least some embodiments, the input layers, X, provide initial data for the GPT, based on a tokenized dataset. The hidden layers, H, between the one or more input layers, X, and the one or more output layers, Y, may process the input information and make connections among the applied tokenized dataset to make predictions. Each neuron in the hidden layer(s) evaluates the tokenized information from the input layer, X, and iteratively finds patterns used for the predictions of the regression test suggestions, using weights to indicate an importance of the inputs and applying them to an activation function or another decision-making process. The output layers, Y, may determine a final prediction of the instructional content by combining information from the hidden layers.

In some embodiments, the GPT is configured to process an input (e.g., a prompt or a query associated with a current transaction, for example) and to generate one or more portions of a response to the current transaction, as discussed further below.

FIG. 3 is a sample table illustrating user information 300 for a given cluster of users in accordance with an illustrative embodiment. In the example of FIG. 3, each user in the given cluster is identified by a user identifier and/or a user name, and the exemplary designated business conditions for each identified user comprise an OTP, a total number of orders, a transactional order mix, a direct order mix, and a business unit order mix. The designated organization conditions may be used to generate a performance rating for each user (e.g., a human representative) in the given cluster. Other business conditions that may be considered, for example, include online revenue per transaction, total revenue per transaction, industry and business unit properties, industry sales volume, business unit sales volume, representative tenure, representative training, total number of interactions, speaking time.

As used herein, the term “tuning,” with respect to a language model, shall be broadly construed to encompass any further training of a pretrained language model, such as a fine-tuning of a language model, using a specialized dataset to adapt the language model to a particular domain and/or task, as would be apparent to a person of ordinary skill in the art.

FIG. 4 illustrates an exemplary fine tuning of multiple language models and a processing of one or more prompts by the one or more of the fine-tuned language models during an inference stage in accordance with an illustrative embodiment. In the example of FIG. 4, user interaction data 410 (e.g., comprising information characterizing interactions of one or more users associated with a given organization, such as a sales representative of the given organization with customers of the given organization) may be processed by subject matter experts, for example, to label user interactions with interaction labels 415 that annotate user interactions as examples of good and bad user interactions and/or where the user interactions may be marked as successful user interactions or unsuccessful user interactions (e.g., with respect to one or more of the designated organization objectives).

A plurality of language models may be fine-tuned at stage 450 using cluster-specific supervised fine tuning and/or RLHF (reinforcement learning from human feedback)-based fine tuning to generate a plurality of cluster-aware language models 470-1 through 470-N for a generative AI engine 460. The fine tuning performed at stage 450 may process the interaction labels 415, domain-specific knowledge 420 (e.g., item catalogs, FAQs, sales playbooks, common objections and their resolutions), user feedback 425 (e.g., performance evaluations, net promoter scores and/or feedback from trainers or customers, such as indications of whether particular users were helpful or accurate) and/or the plurality of clusters 430-1 through 430-N. Thus, the fine tuning of FIG. 4 generates one cluster-aware language model 470 for each cluster 430. In addition, a dedicated chatbot support agent may be associated with each cluster 430 and cluster-aware language model 470, and the appropriate dedicated chatbot support agent may be selected in real-time based on the cluster assignment of a given user and/or the selected designated organization objective being used.

The supervised fine tuning with the domain-specific knowledge 420, for example, ensures that the language models understand the domain-specific terminology and context of an organization. The language models may be finetuned on each specific interaction and/or finetuned on labeled interactions where successful and unsuccessful samples are marked (e.g., positive and negative sampling) to help each language model understand the full conversational context and to learn long term dependencies. If the provided examples only comprise text, it is estimated that 50,000 to 100,000 examples would be a sufficient fine-tuning dataset. If the provided examples comprise instructions (e.g., annotated examples), it is estimated that approximately 10,000 annotated examples would be a sufficient fine-tuning dataset. One representative annotated example comprises:
Input: “How does this model compare with competitors in terms of battery life?”
Output: “Highlight that our model offers longer battery life and direct them to the comparison web page.”

The RLHF-based fine tuning may align the outputs of a language model with one or more designated business objective success metrics. For a sales coaching agent, for example, the one or more designated business objective success metrics may comprise customer satisfaction and/or a percentage of conversions. The RLHF-based fine-tuning process may comprise collecting outputs from the language models during pilot runs; obtain human reviewer ratings of model outputs (e.g., helpfulness and/or accuracy with respect to business objective); train a reward model based on these ratings and using RLHF techniques to fine-tune the language model. In some embodiments, one or more of the cluster-aware language models 470 may be implemented using small language models, for example. Representative annotated examples comprise:
Model Input: Sales representative's incomplete response: “Our warranty policy is...”
Model Output: Correction/completion by language model: “Our warranty policy covers two years of repairs and replacements. Would you like me to email the details?”
Labeled human feedback: “Good correction but could be shorter.”

Model Inputs: Customer: “I need a budget-friendly option;” Sales representative: “We have Model X for $300” and Metadata: Sentiment=Positive and Conversion=Success.
Model Output: “Consider offering a comparison with a slightly higher-priced option to increase upsell potential.”

It is noted that given the positive sentiment and conversion, the support agent is trying to instruct the sales representative to upsell the customer, achieving multiple business objectives or more generalized business objectives. It is estimated that 50,000 to 100,000 examples with human feedback would be a sufficient fine-tuning dataset.

In some embodiments, the RLHF reward function can be extended and made more generalized to move towards a more autonomous, efficient agent that leverages agentic AI. There can be multiple support agents working together focusing on their specific business objectives trained through RLHF, deep learning, ML and/or rule-based learning. This ecosystem of multiple agents is also known as a compounding system.

The language models can be fine-tuned using different methodologies as business objectives are scaled. For example, outcome-supervised reward models (ORMs) may be employed along with process-supervised reward models (PRMs), combined with methods such as Proximal Policy Optimization (PPO) (e.g., to improve a training stability of the support agent by avoiding policy updates that are too large) or a Monte Carlo search tree (MCTS) for training, learning and inference purposes. In these cases, the language model can understand a specific sequence of actions performed by a user along with the text response, and determine the best actions or sequence of actions in a more autonomous way based upon reward functions and/or business objectives.

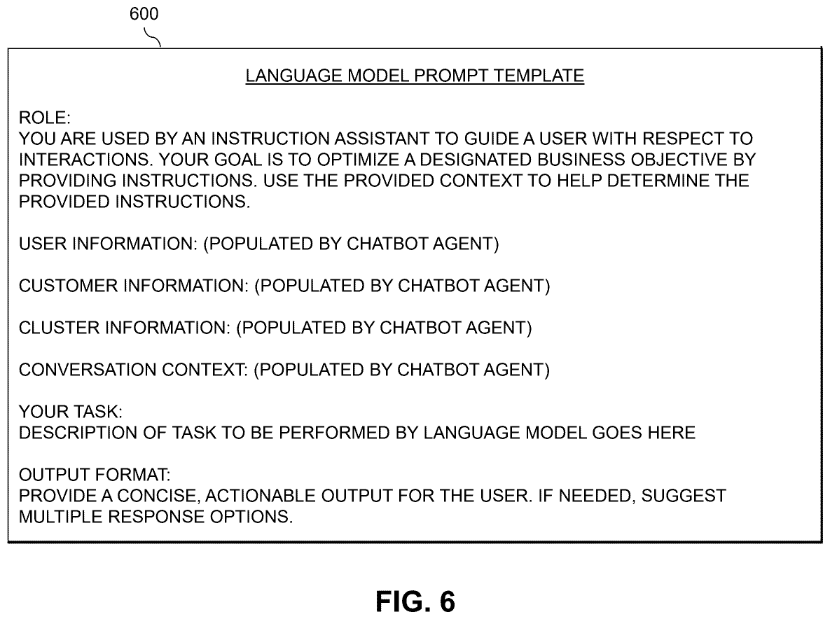

During an inference stage, the particular cluster-aware language model 470 associated with a given interaction may receive one or more inference-stage prompts 480, as discussed further below in conjunction with FIG. 6.

FIG. 5 illustrates an exemplary fine tuning of a global language model 570 and a processing of cluster-based inference stage prompts 580 by the fine-tuned global language model 570 during an inference stage in accordance with an illustrative embodiment. In the example of FIG. 5, one language model may be fine-tuned at stage 550 using supervised fine tuning and/or RLHF-based fine tuning to generate the global language model 570 for a generative AI engine 560. The fine tuning performed at stage 550 may process interaction labels 515 (generated from user interaction data 510 in a similar manner as discussed above in conjunction with FIG. 4), domain-specific knowledge 520 (e.g., item catalogs, FAQs, sales playbooks, common objections and their resolutions), user feedback 525 (e.g., performance evaluations, net promoter scores and/or feedback from trainers or customers, such as indications of whether particular users were helpful or accurate) and/or the plurality of clusters 530-1 through 530-N of the organization. Thus, the fine tuning of FIG. 5 generates one global language model 570 having a dedicated chatbot support agent (not shown in FIG. 5).

In the example of FIG. 5, cluster information is provided to the global language model 570 at the inference stage in the form of cluster-based inference stage prompts 580, as discussed further below in conjunction with FIG. 6. For example, the cluster-based inference stage prompts 580 may identify the cluster associated with a particular user of interest, and/or provide a network address where a cluster assignment table or other cluster information is provided.

FIG. 6 illustrates an exemplary prompt template 600 for a language model in accordance with an illustrative embodiment. In the example of FIG. 6, a representative language model prompt template 600 includes a role section to instruct the language model that it is used by an instruction assistant to guide a user with respect to user interactions. In addition, the language model prompt template 600 provides additional sections to specify additional information related to (i) a user of an organization, (i) a customer of the organization, (iii) a cluster associated with the user and (iv) a conversation context. Finally, the language model prompt template 600 provides a section defining the task to be performed by the language model.

In one example, for real-time instructions, a particular language model generated using the language model prompt template 600 may comprise the following:
Role: You are a language model used by an instruction assistant designed to guide a user (such as a sales representative) during interactions (e.g., with a customer). Your goal is to optimize a specified business objective (e.g., conversion rate, customer retention, upselling) by providing real-time instructions (such as next best action recommendations). Use the context provided below to help the user navigate the conversation effectively with the customer.
User Information: (e.g., populated by a chatbot agent):
Name: [User Name];
Experience Level: [Beginner/Intermediate/Expert];
Performance Summary: [e.g., conversion rate, dollar volume of sales closed, customer satisfaction score];
Common Mistakes: [e.g., talks too much, does not handle objections well, struggles with closing deals];
Coaching Tips: [e.g., focus on active listening, emphasize value over price, ask more open-ended questions].
Customer Information (e.g., populated by a chatbot agent):
Name: [Customer Name];
Industry/Business Type: [e.g., Retail, SaaS (Software as a Service), Manufacturing];
Past Interactions: [e.g., “Customer inquired about product X last week but hesitated due to pricing.”];
Current Preferences and Concerns: [e.g., “Customer prefers cost-effective solutions. Concerned about ROI (return on investment).”];
Sentiment and Engagement Level: [e.g., Engaged, Hesitant, Neutral].
Cluster Information: (e.g., populated by a chatbot agent):
User belongs to Cluster ‘A’. Provide cluster-specific recommendations and when asked a question about a specific cluster, only use information about the specific cluster;
Cluster Name: [Cluster Name];
Cluster Properties: Total Users, Cluster features.
Conversation Context: (e.g., populated by a chatbot agent):
User's Last Message: “[Last thing the sales rep said]”;
Customer's Last Message: “[Last thing the customer said]”;
Current Interaction Stage: [e.g., Initial pitch, objection handling, closing];
Key Challenges in This Interaction: [e.g., price objection, lack of urgency, needs more product information].
Your Task: Based on the above information, guide the user on the best next step.
Suggest how the user should respond;
Highlight key talking points;
If applicable, recommend how to handle objections or how to move the deal forward;
Ensure responses align with best sales practices and customer needs.
Output Format:
Provide a concise, actionable recommendation for the sales representative. If needed, suggest multiple response options.

One example of real-time instructional content (where, for example, one or more language models are integrated into a customer relationship management (CRM) tool or a chat tool for live suggestions) may be expressed as follows:
Model Inputs: Customer: “I'm not sure if I need a subscription service;” Sales representative: “Why don't you try it for free for 30 days?” and Metadata: Sentiment =Uncertain and No Conversion.
Model Output: “Reassure the customer with more benefits of the service and emphasize cancel-anytime flexibility.”

In another example, for post-observation instructions, a particular language model generated using the language model prompt template 600 may comprise the following:
Role: You are a language model used by an instruction assistant designed to provide post-observation feedback to users (e.g., sales representatives). Your goal is to analyze user interactions (e.g., assess performance) and provide actionable coaching insights. You will be given both historical user performance data and a recent user transcript (e.g., of a customer interaction) to evaluate how well the user handled the conversation.
Your feedback should:
Highlight strengths and what the user did well;
Identify missed opportunities or mistakes;
Provide clear, actionable guidance for improvement;
User (Sales Representative) Information:
Name: [User Name];
Experience Level: [Beginner/Intermediate/Expert];
Performance Summary: [e.g., key performance metrics, such as close rate, average deal size, customer sentiment score];
Common Strengths: [e.g., great at building rapport, strong product knowledge];
Common Weaknesses: [e.g., struggles with handling objections, talks too much, fails to ask to close a deal];
Previous Coaching Feedback: [e.g., “Needs to work on active listening and objection handling.”]
Cluster Information: User belongs to Cluster ‘A’. Provide cluster-specific recommendations and when asked a question about a specific cluster, only use information about the specific cluster
Cluster Name: [Cluster Name];
Cluster Properties: Total Users, Cluster features
Conversation Context Overview:
Customer Name: [Customer Name];
Industry: [e.g., SaaS, Retail, Finance];
Customer's Primary Concern or Need: [e.g., looking for cost-effective solutions, hesitant about switching vendors];
Interaction Summary: [Brief context about what was discussed];
Full Interaction Transcript: [Full or summarized transcript of the conversation goes here]

Your Task: Analyze the interaction based on the historical performance of the user and provide detailed feedback in the following format:
1. What Went Well:
   Highlight areas where the User performed strongly;
   Identify good techniques used (e.g., strong rapport-building, effective objection handling, clear value proposition).
2. Areas for Improvement:
   Identify where the user could have handled the task (e.g., a conversation) better;
   Point out missed opportunities (e.g., a failure to ask for the close, not addressing the customer's key pain points).
3. Actionable Recommendations:
   Provide clear, step-by-step advice on how to improve in future interactions;
   Offer specific techniques or strategies that align with best practices.
   Output Format Example
   What Went Well:
   {{⋅ You established strong rapport by asking relevant questions about the customer's business.
   You handled the pricing objection effectively by emphasizing the ROI.}}

Areas for Improvement:
{{⋅ You missed an opportunity to ask for the close when the customer showed buying signals.
Your response to the competitor comparison was too defensive—consider framing it more positively.}}
Actionable Recommendations:
{{⋅ Next time, when a customer gives a buying signal, try a soft close like: “Would it make sense to set up a trial?”
Instead of defending against competitor comparisons, highlight your unique differentiators proactively.}}

One example of post-observation instructional content (where one or more language models may analyze conversations to give personalized instructional feedback (e.g., tone and/or missed opportunities)) may be expressed as follows:
Model Inputs: Customer: “I need a budget-friendly option;” Sales representative: “We have Model X for $300.” and Metadata: Sentiment =Positive and Conversion =Success.
Model Output: “Consider offering a comparison with a slightly higher-priced option during future interactions to increase upsell potential.”

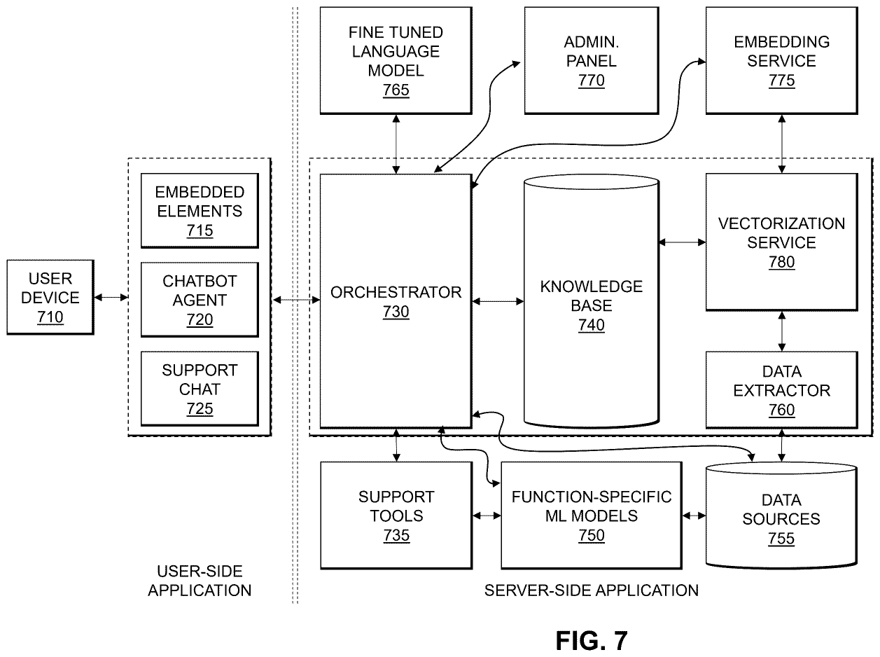

FIG. 7 illustrates an exemplary architecture for cluster-based generation of instructional content using generative AI techniques in accordance with an illustrative embodiment. In the example of FIG. 7, a user device 710, for example, associated with a user (e.g., a sales representative) of an organization, may receive the instructional content generated by means of one or more fine-tuned language models 765 by means of one or more embedded elements 715 (e.g., on a web site), a chatbot agent 720 (e.g., integrated into a mobile application) and/or a support chat 725 (e.g., a customer service support chat).

An orchestrator 730 (e.g., an orchestration service) may coordinate execution of the additional tasks or processes shown in FIG. 7. For example, the orchestrator 730 may provide the user device 710 with access to one or more support tools 735 (e.g., a CRM system) and the one or more fine-tuned language models 765. The user device 710 may also access an administrative panel 770 that provides, for example, question and answer management, prompt engineering, user session logging and additional tasks.

In one or more embodiments, a knowledge base 740 stores domain-specific information, such as item catalogs, FAQs, sales playbooks, common objections and their resolutions. In addition, one or more function-specific ML models 750 may be employed for fraud detection, conversational tone detection and/or conversation sentiment detection. The function-specific ML models 750 may leverage information from one or more data sources 740, such as product data, customer data, sale representative data, cluster data and performance data, as described herein.

In addition, a data extractor 760 may extract data from the one or more data sources 740 to be processed by a vectorization service 750 that converts the extracted data to a vector form, prior to being embedded by an embedding service 775 (e.g., for processing by the one or more fine-tuned language models 765). The embedding service 775 may be implemented using an OpenAI embedding model or Word2Vec models, for example.

The orchestrator 730 can dynamically select an appropriate dedicated chatbot support agent (e.g., and corresponding fine-tuned language model 765) for a given interaction based on the cluster assignment of a given user that is part of the given interaction and/or the selected designated organization objective being used, as would be apparent to a person of ordinary skill in the art.

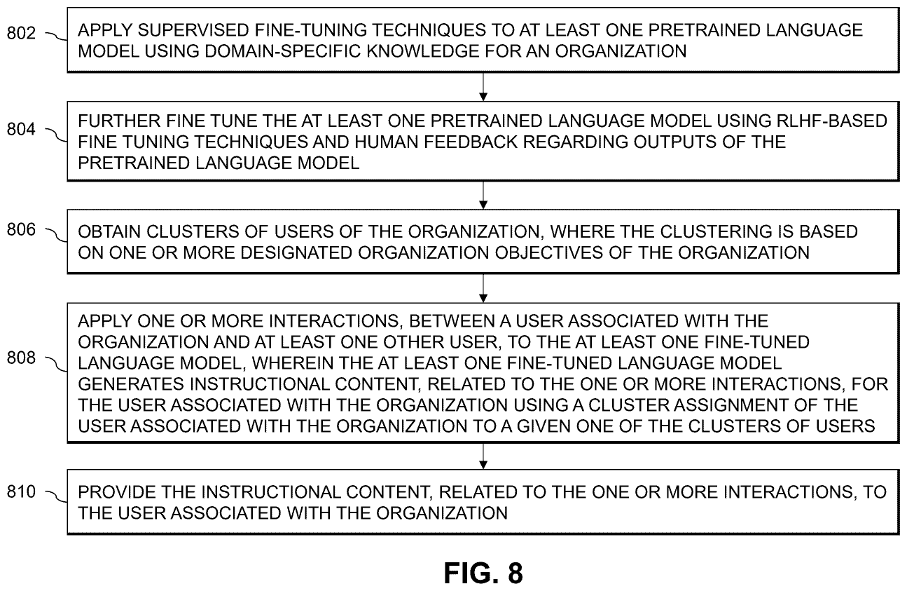

FIG. 8 is a flow diagram illustrating an exemplary implementation of a process for cluster-based generation of instructional content using generative AI techniques in accordance with an illustrative embodiment. In the example of FIG. 8, supervised fine-tuning techniques are applied in step 802 to at least one pretrained language model using domain-specific knowledge for an organization. The at least one pretrained language model is further fine-tuned in step 804 using RLHF-based fine tuning techniques and human feedback regarding outputs of the pretrained language model.

In one or more embodiments, clusters of users of the organization are obtained in step 806, where the clustering is based on one or more designated organization objectives of the organization. One or more interactions, between a user associated with the organization and at least one other user, are applied in step 808 to the at least one fine-tuned language model, wherein the at least one fine-tuned language model generates instructional content, related to the one or more interactions, for the user associated with the organization using a cluster assignment of the user associated with the organization to a given one of the clusters of users. Finally, the instructional content, related to the one or more interactions, is provided in step 810 to the user associated with the organization.

FIG. 9 is a flow diagram illustrating an exemplary implementation of a process for cluster-based generation of instructional content using generative AI techniques in accordance with an illustrative embodiment. In the example of FIG. 9, at least one data structure comprising information characterizing at least a portion of an interaction between at least a first user and a second user is generated in step 902.

At least a portion of the data structure is applied in step 904 to at least one generative AI model, where the generative AI model employs at least one language model that is tuned using labeled interaction data of an organization associated with the first user and domain-specific knowledge for the organization, where the generative AI model generates information characterizing instructional content, related to the interaction, for the first user based at least in part on a cluster assignment of the first user to a given user cluster of a plurality of user clusters, and where the plurality of user clusters is generated by applying a supervised clustering algorithm to (i) one or more attributes of a plurality of users associated with the organization and (ii) at least one designated organization objective of the organization.

At least one automated action is initiated in step 906 based at least in part on the instructional content.

It should be noted that the term “data structure” as used herein is intended to be broadly construed. A data structure, such as any single one of or combination of the data structures referred to above, may provide a portion of a larger data structure, or any one of or combination of the data structures may be combinations of multiple smaller data structures. Therefore, the data structures referred to above may be different parts of a same overall data structure, or one or more of the data structures could be made up of multiple smaller data structures. The data structures may include tables, vectors, embeddings, or various other data structures. In some embodiments, the data structures are specifically formatted or generated such that they are suitable for use as at least one of an input to and an output from an ML model. It should further be appreciated that “generating” a data structure may encompass, for example, populating an existing or previously-created data structure with one or more data items and that “accessing” a data structure may encompass, for example, obtaining a portion (e.g., one or more data items) of one or more data structures by means of a query, select or filter operation, for example.

In at least one embodiment, the generative AI model employs a plurality of language models associated with respective ones of the plurality of user clusters and wherein the language models associated with the given user cluster is used to generate the instructional content, related to the interaction, for the first user. At least one supervised fine-tuning algorithm and/or at least one RLHF algorithm may be used to fine-tune the language model using at least one of the labeled interaction data and the domain-specific knowledge for the organization.

In one or more embodiments, the at least one automated action comprises providing the instructional content to the first user as real-time guidance during the interaction; providing the instructional content to the first user as post-observation guidance following the interaction; generating at least one notification related to the instructional content and/or causing at least one action to be performed in at least one other system using the instructional content. The given user cluster may comprise a ranking of a plurality of users in the given user cluster, wherein the ranking is based at least in part on the at least one designated organization objective, and the instructional content related to the interaction for the first user may be based at least in part on one or more interactions for at least one other user in the given user cluster having a higher ranking than a ranking of the first user. The first user may comprise a chat agent of the organization.

In some embodiments, the process of FIG. 9 further comprises obtaining a current designated business objective, of a plurality of designated business objectives, for the organization and dynamically selecting a given user cluster of the plurality of user clusters based at least in part on the current designated business objective. Each of the plurality of user clusters may have a corresponding chatbot agent and an orchestrator may dynamically select a given chatbot agent based at least in part on one or more of the cluster assignment of the first user and the current designated business objective.

The particular processing operations and other network functionality described in conjunction with FIGS. 2, 4, 5, 8 and 9, for example, are presented by way of illustrative example only, and should not be construed as limiting the scope of the disclosure in any way. Alternative embodiments can use other types of processing operations for cluster-based generation of instructional content using generative AI techniques. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for cluster-based generation of instructional content using generative AI techniques. The foregoing applications and associated embodiments should be considered as illustrative only, and numerous other embodiments can be configured using the techniques disclosed herein, in a wide variety of different applications.

It should also be understood that the disclosed techniques for cluster-based generation of instructional content using generative AI, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for cluster-based generation of instructional content using generative AI may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based instructional content generation engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based instructional content generation platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

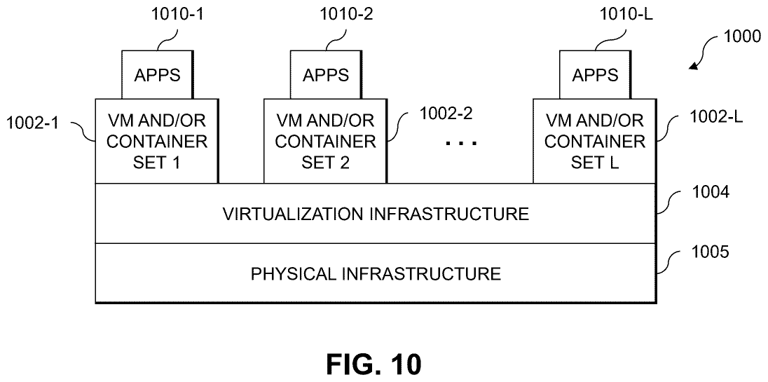

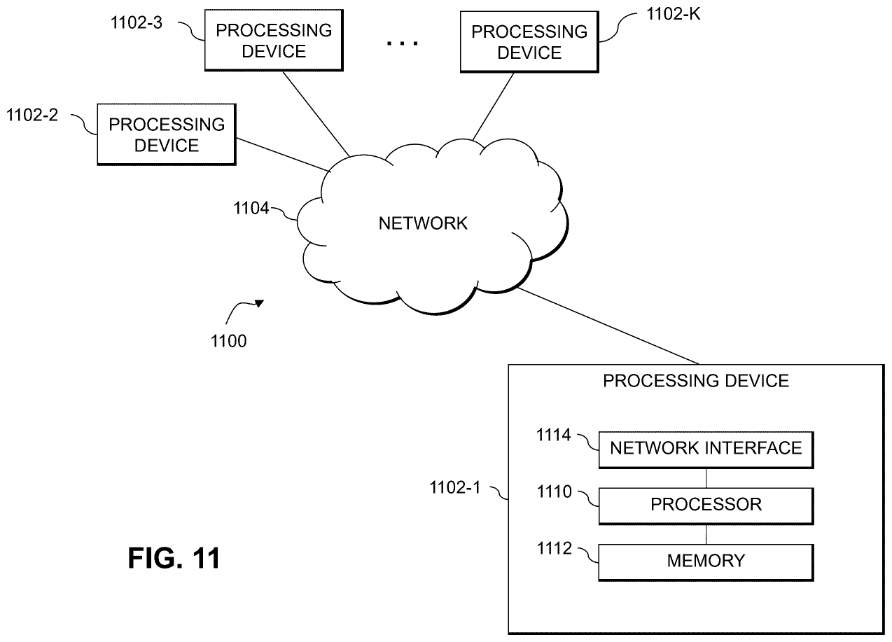

Illustrative embodiments of processing platforms will now be described in greater detail with reference to FIGS. 10 and 11. These platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. Such implementations can provide cluster-based instructional content generation functionality of the type described above for one or more processes running on a given one of the VMs. For example, each of the VMs can implement control logic for cluster-based generation of instructional content and associated functionality for automated processing of such instructional content.

An example of a hypervisor platform that may be used to implement a hypervisor within the virtualization infrastructure 1004 is a compute virtualization platform which may have an associated virtual infrastructure management system such as server management software. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system. Such implementations can provide cluster-based instructional content generation functionality of the type described above for one or more processes running on different ones of the containers. For example, a container host device supporting multiple containers of one or more container sets can implement one or more instances of control logic for cluster-based generation of instructional content and associated functionality for automated processing of such instructional content.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises at least a portion of the given system and includes a plurality of processing devices, denoted 1102-1, 1102-2, 1102-3, . . . 1102-K, which communicate with one another over a network 1104. The network 1104 may comprise any type of network, such as a WAN, a LAN, a satellite network, a telephone or cable network, a cellular network, a wireless network such as WiFi or WiMAX, or various portions or combinations of these and other types of networks.

The processing device 1102-1 in the processing platform 1100 comprises a processor 1110 coupled to a memory 1112. The processor 1110 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 1112, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 10 or 11, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
generating at least one data structure comprising information characterizing at least a portion of an interaction between at least a first user and a second user;
applying at least a portion of the data structure to at least one generative artificial intelligence (AI) model, wherein the generative AI model employs at least one language model that is tuned using labeled interaction data of an organization associated with the first user and domain-specific knowledge for the organization, wherein the generative AI model generates information characterizing instructional content, related to the interaction, for the first user based at least in part on a cluster assignment of the first user to a given user cluster of a plurality of user clusters, and wherein the plurality of user clusters is generated by applying a supervised clustering algorithm to (i) one or more attributes of a plurality of users associated with the organization and (ii) at least one designated organization objective of the organization; and
initiating at least one automated action based at least in part on the instructional content;
wherein the method is performed by at least one processing device comprising a processor coupled to a memory.

2. The method of claim 1, wherein the generative AI model employs a plurality of language models associated with respective ones of the plurality of user clusters and wherein the language models associated with the given user cluster is used to generate the instructional content, related to the interaction, for the first user.

3. The method of claim 1, wherein at least one supervised fine-tuning algorithm is used to fine-tune the language model using at least one of the labeled interaction data and the domain-specific knowledge for the organization.

4. The method of claim 1, wherein at least one reinforcement learning from human feedback algorithm is used to fine-tune the language model using at least one of the labeled interaction data and the domain-specific knowledge for the organization.

5. The method of claim 1, wherein the at least one automated action comprises one or more of: providing the instructional content to the first user as real-time guidance during the interaction;
providing the instructional content to the first user as post-observation guidance following the interaction; generating at least one notification related to the instructional content and causing at least one action to be performed in at least one other system using the instructional content.

6. The method of claim 1, wherein the given user cluster comprises a ranking of a plurality of users in the given user cluster, wherein the ranking is based at least in part on the designated organization objective, and wherein the instructional content related to the interaction for the first user is based at least in part on one or more interactions for at least one other user in the given user cluster having a higher ranking than a ranking of the first user.

7. The method of claim 1, wherein the first user comprises a chat agent of the organization.

8. The method of claim 1, further comprising obtaining a current designated business objective, of a plurality of designated business objectives, for the organization and dynamically selecting a given user cluster of the plurality of user clusters based at least in part on the current designated business objective.

9. The method of claim 8, where each of the plurality of user clusters has a corresponding chatbot agent and wherein an orchestrator dynamically selects a given chatbot agent based at least in part on one or more of the cluster assignment of the first user and the current designated business objective.

10. An apparatus comprising:
at least one processing device comprising a processor coupled to a memory;
the at least one processing device being configured to implement the following steps:
generating at least one data structure comprising information characterizing at least a portion of an interaction between at least a first user and a second user;
applying at least a portion of the data structure to at least one generative artificial intelligence (AI) model, wherein the generative AI model employs at least one language model that is tuned using labeled interaction data of an organization associated with the first user and domain-specific knowledge for the organization, wherein the generative AI model generates information characterizing instructional content, related to the interaction, for the first user based at least in part on a cluster assignment of the first user to a given user cluster of a plurality of user clusters, and wherein the plurality of user clusters is generated by applying a supervised clustering algorithm to (i) one or more attributes of a plurality of users associated with the organization and (ii) at least one designated organization objective of the organization; and
initiating at least one automated action based at least in part on the instructional content.

11. The apparatus of claim 10, wherein the generative AI model employs a plurality of language models associated with respective ones of the plurality of user clusters and wherein the language models associated with the given user cluster is used to generate the instructional content, related to the interaction, for the first user.

12. The apparatus of claim 10, wherein one or more of: at least one supervised fine-tuning algorithm and at least one reinforcement learning from human feedback algorithm is used to fine-tune the language model using at least one of the labeled interaction data and the domain-specific knowledge for the organization.

13. The apparatus of claim 10, wherein the given user cluster comprises a ranking of a plurality of users in the given user cluster, wherein the ranking is based at least in part on the designated organization objective, and wherein the instructional content related to the interaction for the first user is based at least in part on one or more interactions for at least one other user in the given user cluster having a higher ranking than a ranking of the first user.

14. The apparatus of claim 10, further comprising obtaining a current designated business objective, of a plurality of designated business objectives, for the organization and dynamically selecting a given user cluster of the plurality of user clusters based at least in part on the current designated business objective.

15. The apparatus of claim 14, where each of the plurality of user clusters has a corresponding chatbot agent and wherein an orchestrator dynamically selects a given chatbot agent based at least in part on one or more of the cluster assignment of the first user and the current designated business objective.

16. A non-transitory processor-readable storage medium having stored therein program code of one or more software programs, wherein the program code when executed by at least one processing device causes the at least one processing device to perform the following steps:
generating at least one data structure comprising information characterizing at least a portion of an interaction between at least a first user and a second user;
applying at least a portion of the data structure to at least one generative artificial intelligence (AI) model, wherein the generative AI model employs at least one language model that is tuned using labeled interaction data of an organization associated with the first user and domain-specific knowledge for the organization, wherein the generative AI model generates information characterizing instructional content, related to the interaction, for the first user based at least in part on a cluster assignment of the first user to a given user cluster of a plurality of user clusters, and wherein the plurality of user clusters is generated by applying a supervised clustering algorithm to (i) one or more attributes of a plurality of users associated with the organization and (ii) at least one designated organization objective of the organization; and
initiating at least one automated action based at least in part on the instructional content.

17. The non-transitory processor-readable storage medium of claim 16, wherein the generative AI model employs a plurality of language models associated with respective ones of the plurality of user clusters and wherein the language models associated with the given user cluster is used to generate the instructional content, related to the interaction, for the first user.

18. The non-transitory processor-readable storage medium of claim 16, wherein one or more of: at least one supervised fine-tuning algorithm and at least one reinforcement learning from human feedback algorithm is used to fine-tune the language model using at least one of the labeled interaction data and the domain-specific knowledge for the organization.

19. The non-transitory processor-readable storage medium of claim 16, wherein the given user cluster comprises a ranking of a plurality of users in the given user cluster, wherein the ranking is based at least in part on the designated organization objective, and wherein the instructional content related to the interaction for the first user is based at least in part on one or more interactions for at least one other user in the given user cluster having a higher ranking than a ranking of the first user.

20. The non-transitory processor-readable storage medium of claim 16, further comprising obtaining a current designated business objective, of a plurality of designated business objectives, for the organization and dynamically selecting a given user cluster of the plurality of user clusters based at least in part on the current designated business objective, where each of the plurality of user clusters has a corresponding chatbot agent and wherein an orchestrator dynamically selects a given chatbot agent based at least in part on one or more of the cluster assignment of the first user and the current designated business objective.
